(19) United States
(12) Patent Application Publication
(10) Pub. No.: US 2023/0400569 A1
(43) Pub. Date: Dec. 14, 2023

(54) APPARATUS AND METHOD FOR LASER RANGE-FINDING

(71) Applicant: RAFAEL ADVANCED DEFENSE SYSTEMS LTD., Haifa (IL)

(72) Inventors: Daniel GOLUBCHIK, Kiryat Bialik (IL); Ahron MALINE, Karmiel (IL)

(21) Appl. No.: 18/036,427

(22) PCT Filed: Dec. 2, 2021
(86) PCT No.: PCT/IB2021/061249

§ 371 Date: May 11, 2023

(30) Foreign Application Priority Data
Dec. 8, 2020 (IL) 279280

(51) Int. Cl. G01S 13/86; G01S 7/481; G01S 17/08; G01S 13/08; G01C 3/02

(52) U.S. Cl. CPC G01S 13/865; G01S 7/4815; G01S 17/08; G01S 13/08; G01C 3/02

(57) ABSTRACT

A range-finding apparatus and method for measuring the range of a target illuminated by a coherent beam combining (CBC) system having at least two partially coherent sub-beams. The apparatus includes a phase modulation controller and a signal processor. The controller provides one or more optical phase modulation signals to the CBC system. The signal processor receives an initial measurement of target range, provided by either the CBC system or an external range-finding device and having a relatively large uncertainty, and a time-varying received intensity signal provided by the CBC system. The signal processor calculates frequency components of the intensity signal, forms rotated frequency components corresponding to a time-of-flight correction, calculates an objective function depending upon the rotated frequency components, determines a global minimum of the objective function, and calculates a corrected measurement of target range having an uncertainty which is less than that of the initial measurement of target range.

### FIELD OF THE INVENTION

The present invention relates to laser range-finding, and, in particular, to an apparatus and method for accurately measuring range to a target illuminated by a coherent beam combining (CBC) system.

### BACKGROUND OF THE INVENTION

In electromagnetic range-finding systems, the range to a target is found by measuring the time-of-flight (TOF) of an electromagnetic wave as it propagates from a source to a target and from the target to a receiver. The source generally transmits a modulated signal, which may be a pulsed wave or a continuous wave having amplitude, or intensity, modulation. The TOF measurement accuracy depends primarily on the modulation bandwidth, which is typically much higher for laser systems than for microwave systems, and on the signal-to-noise ratio of the reflected signal from the target.

In prior art laser range-finding systems based upon coherent detection, optical interference is used to measure the relative optical phase between the beam reflected by a target and a delayed portion of the beam emitted by the laser source. Coherent detection requires the source to have a coherence length which is a substantial fraction of the target range. This limits the available power and useful range of coherent detection systems.

An article by Chen Yu et. al., entitled “Multi-Frequency Modulation Laser Range Finding System” and appearing in Modern Applied Science, Vol. 9, No. 4, in 2015, presents a range finding system using a Multiple Frequency Phase Shift (MFPS) method. In this method, the intensity of a seed laser source is modulated in time by a signal having several frequencies. The reflected signal is demodulated and a TOF estimate is generated using a coordinate rotation angle solver algorithm.

In directed energy applications, the system imposes stringent constraints on the required accuracy and update rate of range measurements. Exemplary requirements are a range measurement accuracy of ±1 meter at a target range of at least one kilometer. Assuming a nominal light velocity (c) equal to 3×10⁸ meters/sec, the target TOF for two-way (round trip) propagation is at least (2×1000 meters/c)=6.67 microseconds (μsec), and the required TOF measurement accuracy is (2×±1 meter/c)=±6.67 nanoseconds (nsec). Furthermore, if the target is moving radially with respect to the source at, say, 100 meters/sec, the required update rate may well exceed one thousand measurements per second.

Prior art laser range-finders are unable to achieve a suitable combination of laser power, intensity modulation bandwidth, and laser coherence length which satisfies the above requirements with respect to target range, and TOF measurement accuracy and update rate.

In a CBC system, several laser sub-beams are formed by amplifying a seed laser, and are combined in phase to form an outgoing beam. A beam director optical system steers the beams to illuminate and overlap at a point on the target surface. CBC systems are power scalable, and a laser power on the order of several kilowatts has been demonstrated. A portion of the illumination is reflected from the target in the direction of a receiver telescope and is processed by optical and electrical hardware components to form a time-varying received signal. The received signal is analyzed, for example in a Target-in-the-Loop (TIL) system, in order to measure and control the relative phases between the sub-beams.

### SUMMARY OF THE INVENTION

The invention overcomes the limitations of the prior art by providing an apparatus and method for accurate range-finding for a target illuminated by at least two sub-beams of a coherent beam combining (CBC) system. The invention utilizes optical phase modulation of laser sub-beams having relatively low coherence length, in order to achieve a high TOF measurement accuracy and a high TOF measurement update rate, even in the presence of electronic noise.

According to one aspect of the presently disclosed subject matter, there is provided a range-finding apparatus in communication with a coherent beam combining (CBC) system which illuminates a target with at least two partially coherent sub-beams, the apparatus including a phase modulation controller providing at least one optical phase modulation signal to the CBC system, and a signal processor configured to receive a time-varying received intensity signal from the CBC system and to receive an initial measurement of target range having an initial uncertainty. The signal processor is configured to calculate frequency components of the received intensity signal; to form rotated frequency components by rotating the frequency components through an angle proportional to a time-of-flight correction; to calculate an objective function depending upon the rotated frequency components; to determine a global minimum of the objective function; and to calculate a corrected measurement of target range having an uncertainty which is less than the initial uncertainty.

According to some aspects, the at least one optical phase modulation signal includes a sinusoidal frequency or a linear frequency modulation signal.

According to some aspects, at least one optical phase modulation signal has a bandwidth whose value is in a range of ten kilohertz to one hundred megahertz.

According to some aspects, the frequency components include fundamental and second harmonic frequencies of the received intensity signal.

According to some aspects, the signal processor sends feedback to the phase modulation controller including one or more updated parameters of the at least one optical phase modulation signal.

According to some aspects, the initial measurement of target range is provided by the CBC system or by an external range-finding device.

According to some aspects, the external range-finding device is selected from a group including a microwave radar, a millimeter-wave radar, and a forward looking infrared system.

According to some aspects, the objective function depends upon absolute values of the rotated frequency components.

According to some aspects, the objective function includes a sum-of-absolute-values objective function and/or a sum-of-squares objective function.

According to some aspects, the corrected measurement of target range has an uncertainty which is equal in value to the initial uncertainty divided by a factor of at least 300.

According to some aspects, the at least two partially coherent sub-beams have coherence lengths whose values are less than or equal to one meter.

According to another aspect of the presently disclosed subject matter, there is provided a range-finding method for use with a coherent beam combining (CBC) system which illuminates a target with at least two partially coherent laser sub-beams; and the method includes the following steps:
a) providing a CBC system including at least two partially coherent laser sub-beams and an optical phase modulator;
b) sending at least one optical phase modulation signal to the CBC system;
c) receiving a time-varying received intensity signal from the CBC system, and an initial measurement of target range from either the CBC system or an external range-finding device; and
d) calculating a corrected measurement of target range having an uncertainty which is less than that of the initial measurement.

According to some aspects, step d) of the range-finding method further includes the following steps:
e) calculating frequency components of the intensity signal;
f) rotating the frequency components through an angle proportional to a time-of-flight correction;
g) calculating an objective function depending on the rotated frequency components; and
h) determining a global minimum of the objective function.

### BRIEF DESCRIPTION OF THE DRAWINGS

The invention is herein described, by way of example only, with reference to the accompanying drawings Like reference numerals are used to denote similar or like elements in the drawings.

FIG. 1 is a schematic representation of the major components of an exemplary range-finding apparatus, according to the invention.

FIG. 2 is a plot of an exemplary objective function F(δt), with and without noise.

FIG. 3 is a plot of an exemplary TOF measurement success ratio versus noise spectral density.

FIG. 4 is a block diagram of an exemplary range-finding method, according to the principles of the invention.

### DETAILED DESCRIPTION OF THE PREFERRED EMBODIMENTS

The invention is an apparatus and method for accurate range-finding of a target illuminated by sub-beams of a CBC system. The principles and practical use of the invention may be better understood with reference to the drawings and the accompanying description.

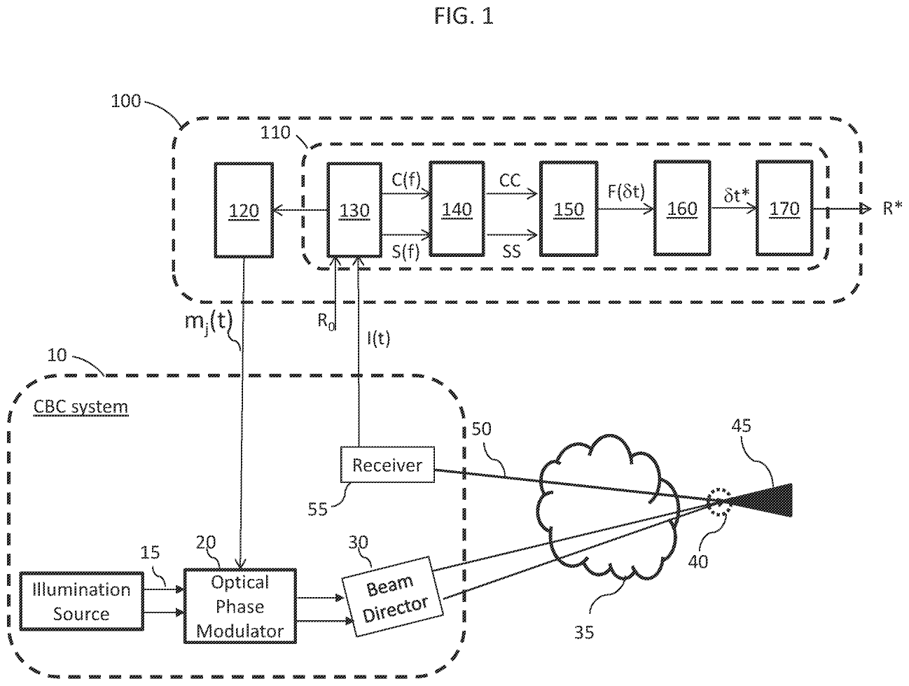

FIG. 1 shows a schematic representation of an exemplary range-finding apparatus 100 according to the invention. Phase modulation controller 120 sends at least one time-varying optical phase modulation signal to an optical phase modulator 20 in a CBC system 10. Modulator 20 applies the phase modulation to at least one of the high-power laser sub-beams emitted by the CBC illumination source.

The coherence length of each of the laser sub-beams 15 may typically be on the order of one meter or less. Consequently, optical path differences between the sub-beam sources must be adjusted with millimeter precision to ensure coherent combining. By way of comparison with the prior art, existing high-power laser rangefinders that use coherent detection typically require a laser coherence length of the order of at least several meters, and in some cases tens or hundreds of kilometers. On leaving modulator 20, the relative optical phases of the sub-beams include additional phase shifts caused by electronic noise, acoustic vibrations, and thermal variations present in the optical path of the sub-beams.

The sub-beams 15 are numbered j=1 to N (N≥2), where N is the total number of sub-beams, including both un-modulated and modulated sub-beams. The optical phase modulation signal of the j-th sub-beam is zero if the beam is un-modulated and is a non-zero, time-varying function, mⱼ(t), if the sub-beam is modulated. The functions m 3 (t) have a bandwidth in the Fourier domain which may range from kilohertz (KHz) to gigahertz (GHz) depending on the required accuracy of the range measurement. Non-limiting, exemplary optical phase modulation signals include linear frequency modulation (LFM), or “chirp”, signals and sinusoidal signals. The latter have the form:

mⱼ(t)=Aⱼ sin(2πfⱼt)+Bⱼ (for j=1 to N) (Equation 1)

where, for the j-th modulated sub-beam, fⱼ is the modulation frequency, Aⱼ is a constant modulation amplitude, and Bⱼ is a constant phase offset. Exemplary values of fⱼ are between kilohertz (KHz) and 100 megahertz (MHz).

Phase modulation controller 120 provides the voltages and frequencies required for the optical phase modulation of the sub-beams. For example, in the case of an electro-optical modulator, such as Thorlabs® LN81S-FC, the voltage required to change the phase by π is approximately 6V. To provide this voltage, controller 120 may, for example, convert a digital signal to analog using a digital-to-analog converter (DAC), or a voltage-controlled oscillators (VCO), followed by an RF amplifier to reach the required voltage level.

In FIG. 1, a CBC beam director 30 steers the sub-beams with high angular accuracy, typically on the order of a few micro-radians, so that the sub-beams overlap and form a single combined spot 40 on a surface of a target 45. As they propagate through the atmosphere, the sub-beams accumulate relative phase differences, such as time-varying perturbations cause by moving air masses in a region 35 of atmospheric turbulence. Thus, the relative optical phases of the sub-beams impinging on the target are generally not known a priori.

At the surface of the target, the total time-varying complex electric field, U(t), may be represented by U(t)=Σ Uⱼ(t) where the summation is over all of the sub-beams, namely j=1 to N. The time-varying complex electric field of the j-th sub-beam, Uⱼ(t), is given by,

Uⱼ(t)=uⱼ expi{−2πct/λ+ϕⱼ(t)+mⱼ(t)} (Equation 2)

Here uⱼ is an unknown positive amplitude, i=√−1, “exp” is the exponential function, “c” is the speed of light, and λ is the wavelength of sub-beam, typically belonging to the visible or infrared light spectrum. The functions ϕⱼ(t) represent unknown relative phases contributed by such physical effects as atmospheric turbulence and target motion. These effects generally have frequency bandwidths in the KHz range or below, which is well below the frequency bandwidths of the optical phase modulation signals mⱼ(t) provided by controller 120, which are typically in the MHz range.

A portion of the illumination impinging on the target forms a reflected beam 50, which is detected by CBC receiver 55. at distances of several kilometers, the received beam may be 9 to 12 orders of magnitude smaller than the illumination power emitted by the CBC system. Receiver 55 typically includes a telescopic optical system with an entrance aperture for the reflected beam, a high-gain, low-noise detector, such as Thorlabs® APD130C.

The received intensity signal I(t) is proportional to |U(t)|² and involves many inter-modulation product terms. If mⱼ(t) is a sinusoidal function with frequency fⱼ, I(t) includes sinusoidal terms having a frequency fⱼ, second-harmonic terms having a frequency 2fⱼ, and other terms involving frequency sums and differences, such as fⱼ±fₙ(n≠j).

Range-finding apparatus 100 includes a real-time signal processor 110 which is configured to receive the signal I(t) and to extract the target TOF information by performing a sequence of signal processing algorithms represented by blocks 130, 140, 150, 160, and 170 in FIG. 1. The signal processor 110 is typically implemented by a field-programmable gate array (FPGA) or an application-specific integrated circuit (ASIC).

Block 130 has several real-time functions. First, block 130 digitizes the received intensity signal I(t), provided by receiver 55, typically using an analog-to-digital converter (ADC) having a bandwidth at least 10 times higher than the highest modulation frequency.

Second, block 130 receives a coarse estimate of target range, R₀, which may be provided by an external sensor or by the CBC system 10. For example, the external sensor may be a microwave radar, a millimeter-wave radar, or a forward looking infrared (FLIR) system. Alternatively, the coarse estimate of target range may be provided by a range-finding apparatus similar to that of the invention, but with optical phase modulation signals having lower frequencies, for example 10 to 100 KHz. The uncertainty of coarse estimate R₀ is denoted by ±ΔR. Based on R₀, a coarse estimate of TOF is given by T₀=2R₀/c, with an uncertainty of ±ΔT=±2ΔR/c.

Third, block 130 calculates the quadrature and in-phase frequency components of I(t) (often called “I-Q components” or “orthogonal components”) as follows:

C(f)=∫I(t)cos 2πf(t−T₀)dt (Equation 3)

S(f)=∫I(t)sin 2πf(t−T₀)dt (Equation 4)

The above integrals are evaluated over a time interval |t−T₀|≤W for any given frequency, f. In the case of sinusoidal frequency modulation, the frequency components having large magnitudes are generally those corresponding to the fundamental frequency fⱼ, and to its second harmonic frequency, 2fⱼ. In the case of more general modulation functions which are not sinusoidal, the equations 3 and 4 may be replaced by Hilbert transforms, as is known to those skilled in the art of signal processing. Typically, the integration time, 2 W, depends upon the signal-to-noise ration of I(t), and is on the order of 10 to 100 μsec. The calculated values of C(f) and S(f) may be used to update the phase offsets Bⱼ in equation 1, and to feedback the updated parameters to the modulation controller 120, so as to enable coherent combination of the sub-beams at the target.

Block 140 rotates the frequency components C(f) and S(f) through an incremental phase angle (2πf δt), where δt is a TOF correction that is yet to be determined. The rotated frequency components are given by:

CC(f,δt)=C(f)cos 2πfδt+S(f)sin 2πfδt (Equation 5)

SS(f,δt)=−S(f)cos 2πfδt+C(f)sin 2πfδt (Equation 6)

Block 150 calculates an objective function, F(δt). The objective function is defined by:

F(δt)=Σ|CC(fⱼ,δt)|^{p}+|SS(2fⱼ,δt)|^{p} (Equation 7)

where the summation is over all of the sub-beams, j=1 to N. The power “p” may be a positive integer or a fractional value which is greater than 0. When p=1, the function F is referred to as a “sum-of-absolute-values” objective function; when p=2, it is referred to as a “sum-of-squares” objective function.

The function F(δt) generally has many local minima, however, it achieves its global minimum value when δt is equal to the true target TOF minus T0. Physically, the global minimum of F occurs when both the CC term, which involves a quadrature component of the first harmonics, and the SS term, which involves an in-phase component of the second harmonics, are of small magnitude.

In general, the objective function of equation 7 may be extended to include terms with other frequency combinations, besides the fundamental and second harmonics of fⱼ. However, simulation results indicate that the objective function in equation 7 yields range estimates of very high accuracy, with no additional terms.

Block 160 determines a global minimum of the objective function F(δt), over an interval |δt|≤ΔT, corresponding to the uncertainty of the initial TOF estimate T₀. To avoid choosing one of the local minima of F(δt), the above interval is divided into a grid of closely spaced points, whose δt values are separated, for example, by 1 nsec. or less, and the numerical values of F are calculated using equation 7. The point (δtₘᵢₙ, Fₘᵢₙ) corresponding to the global minimum is selected, and the value δt*=δtₘᵢₙ is chosen as a measurement of the TOF correction.

In the presence of noise in the received intensity signal I(t), the accuracy of the TOF measurement may be improved through integration. One method of integration is to form a set of objective functions {Fₖ(δt), k=1 to K}, where each Fₖ corresponds to a different subset of the N sub-beams, or to a different integration time interval in equations 3 and 4. The objective function F obtained by summing the K objective functions Fₖ is used to find a global minimum point and the corresponding measured TOF correction, δt*=δtₘᵢₙ.

A second method of integration is to fit a spline curve to several points in the neighborhood of the point (δtₘᵢₙ, Fₘᵢₙ), and then to find the value at which the fitted spline curve has its minimum value. By combining data from neighboring points, the accuracy of the measured TOF correction is generally improved.

Block 170 calculates a corrected value of the target range, R*, given by:

R*=R₀+cδt*/2 (Equation 8)

The update rate of R* depends on the integration time 2 W and the calculation time for minimizing the objective function F, and is, for example, between 5 and 50 KHz.

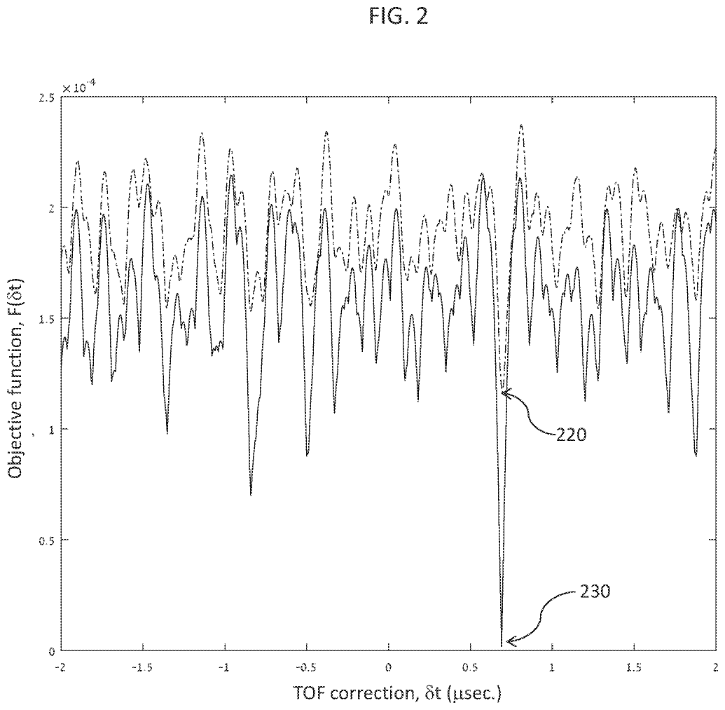

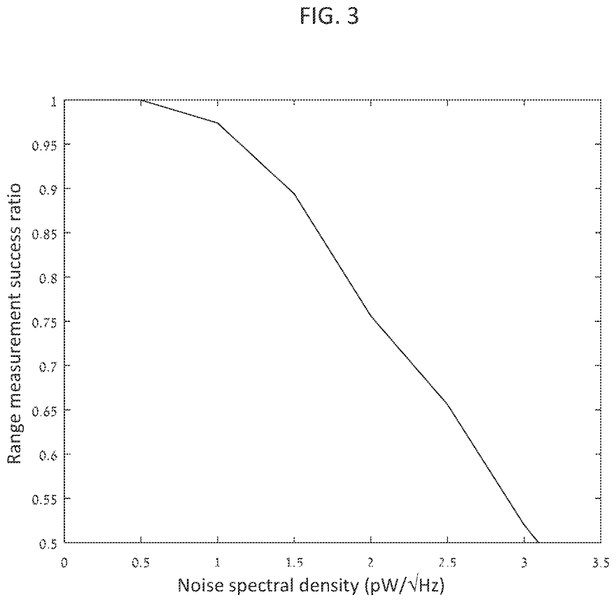

FIGS. 2 and 3 show plots that illustrate the excellent noise robustness of the range-finding apparatus and method, according to the invention. The plots are based upon digital simulations of laser beams and optical detection in the presence of noise. In the simulations, the signal I(t) has an average power of 1 nano-watt (nW). The noise in I(t) is white and Gaussian, with a variable noise spectral density, measured in units of pico-watts per square-root hertz (pW/√Hz). The initial range measurement R₀ has an uncertainty of ±ΔR=±300 meters, corresponding to a coarse TOF uncertainty of ±ΔT=±2ΔR/c=±2 microseconds (μsec.). In the prototype apparatus, there are 8 groups of sub-beams. Each group consists of 4 sub-beams, each having a sinusoidal optical phase modulation at a different frequency (N=4). Each of the 8 groups generates an objective function Fₖ, and the summed objective function, F=Σ Fₖ, is used to find a global minimum point and the associated TOF correction, δt*.

FIG. 2 shows a plot of an exemplary objective function F(δt), with and without noise, versus the TOF correction, δt, in units of μsec. The solid curve and the dashed curve correspond to the case of a noise-free and a noisy received intensity signal, I(t), respectively. The signal integration time is 2 W=16 microsec., the noise spectral density for the dashed curve is equal to 2 pW/√Hz, and the value p=1 is used in equation 7. Arrows 220 and 230 indicate the global minimum points of F in the noisy and noise-free cases, respectively. The global minimum points occur at nearly the same value of δt, indicating that the effect of noise on the measured value of the TOF correction is very small in this case. As the noise level increases, the measurement accuracy deteriorates, and at very high noise levels, the presence of many local minima may lead to difficulty in identifying the correct global minimum and to measurement failure.

FIG. 3 shows a plot of an exemplary range measurement success ratio versus noise spectral density, in units of pW/√Hz. A measurement success is defined as a simulation run in which the corrected range measurement, given by equation 8, is within ±1 meter of the true target range, for an initial range uncertainty of ±300 meters. This represents an uncertainty improvement factor of at least 300:1. According to FIG. 3, at noise spectral densities below 1.0 pW/√Hz, the success ratio is seen to be greater than or equal to 97%.

Repeat simulations indicate that the sum-of-absolute-values objective function (with p=1 in equation 7) generally yields better range correction measurements, in terms of uncertainty improvement factor and success ratio, than the sum-of-squares (p=2) objective function.

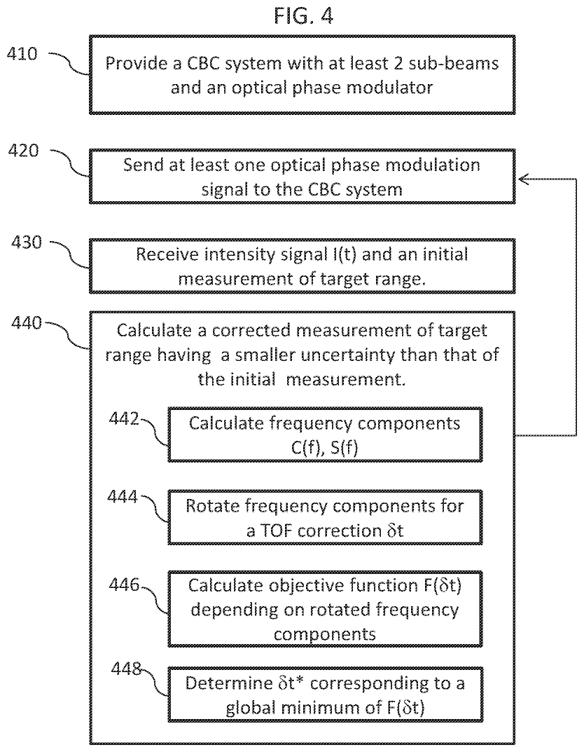

FIG. 4 is a block diagram of an exemplary range-finding method, according to the principles of the invention. The method includes the following steps:
Step 410: providing a CBC system with at least two partially coherent laser sub-beams and an optical phase modulator;
Step 420: sending at least one optical phase modulation signal to the CBC system;
Step 430: receiving a received intensity signal, I(t), from the CBC system, and an initial measurement of target range, from either the CBC system or an external range-finding device; and
Step 440: calculating a corrected measurement of target range having a smaller uncertainty than that of the initial measurement, using equation 8.

In an exemplary implementation of the method, step 440 may include the following additional steps:
Step 442: calculating frequency components of the intensity signal, using equations 3 and 4;
Step 444: rotating the frequency components C(f) and S(f), for a TOF correction, δt, using equations 5 and 6;
Step 446: calculating an objective function F(δt) depending on the rotated frequency components, using equation 7; and
Step 448: determining δt* corresponding to a global minimum of F(δt).

It will be appreciated that the above descriptions are intended only to serve as examples, and that many other embodiments are possible within the scope of the present invention as defined in the appended claims. For example, the algorithms performed by signal processor 110 may be implemented by a combination of one or more FPGAs, ASICs, and programmable signal processors. Alternatively, some or all of the signal processing may be relegated to the CBC system. Furthermore, many other configurations of the apparatus and method of the invention, besides those explicitly shown in FIGS. 1 and 4, respectively, will be readily apparent to those skilled in the art of laser range-finding, based upon the principles disclosed herein.

1. A range-finding apparatus in communication with a coherent beam combining (CBC) system which illuminates a target with at least two partially coherent sub-beams, the apparatus comprising:
a phase modulation controller providing at least one optical phase modulation signal to the CBC system;
a signal processor configured to receive a time-varying received intensity signal from the CBC system and to receive an initial measurement of target range having an initial uncertainty;
the signal processor further configured to calculate frequency components of the received intensity signal; to form rotated frequency components by rotating said frequency components through an angle proportional to a time-of-flight correction; to calculate an objective function depending upon the rotated frequency components; to determine a global minimum of the objective function; and to calculate a corrected measurement of target range having an uncertainty which is less than the initial uncertainty.

2. The apparatus of claim 1 wherein the at least one optical phase modulation signal comprises a sinusoidal frequency or a linear frequency modulation signal.

3. The apparatus of claim 1 wherein the at least one optical phase modulation signal has a bandwidth whose value is in a range of ten kilohertz to one hundred megahertz.

4. The apparatus of claim 1 wherein the frequency components comprise fundamental and second harmonic frequencies of the received intensity signal.

5. The apparatus of claim 1 wherein the signal processor sends feedback to the phase modulation controller comprising one or more updated parameters of the at least one optical phase modulation signal.

6. The apparatus of claim 1 wherein the initial measurement of target range is provided by the CBC system or by an external range-finding device.

7. The apparatus of claim 6 wherein the external range-finding device is selected from a group comprising a microwave radar, a millimeter-wave radar, and a forward looking infrared system.

8. The apparatus of claim 1 wherein the objective function depends upon absolute values of the rotated frequency components.

9. The apparatus of claim 8 wherein the objective function comprises a sum-of-absolute-values objective function and/or a sum-of-squares objective function.

10. The apparatus of claim 1 wherein the corrected measurement of target range has an uncertainty which is equal in value to the initial uncertainty divided by a factor of at least 300.

11. The apparatus of claim 1 wherein the at least two partially coherent sub-beams have coherence lengths whose values are less than or equal to one meter.

12. A range-finding method for use with a coherent beam combining (CBC) system which illuminates a target with at least two partially coherent laser sub-beams, the method comprising the steps:
(a) providing a CBC system comprising at least two partially coherent laser sub-beams and an optical phase modulator;
(b) sending at least one optical phase modulation signal to the CBC system;
(c) receiving a time-varying received intensity signal from the CBC system, and an initial measurement of target range from either the CBC system or an external range-finding device; and
(d) calculating a corrected measurement of target range having an uncertainty which is less than that of the initial measurement.

13. The method of claim 12 wherein step (d) further comprises the steps:
(e) calculating frequency components of the intensity signal;
(f) rotating the frequency components through an angle proportional to a time-of-flight correction;
(g) calculating an objective function depending on the rotated frequency components; and
(h) determining a global minimum of the objective function.
